(19) United States
(12) Patent Application Publication
(10) Pub. No.: US 2007/0043729 A1
(43) Pub. Date: Feb. 22, 2007

(54) Secret identifier for renewed subscription

(75) Inventor: Thomas Andreas Maria Kevenaar, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, 5621 BA EINDHOVEN (NL)

(21) Appl. No.: 10/552,780

(22) PCT Filed: Apr. 15, 2004
(86) PCT No.: PCT/IB04/50456

§ 371 Date: Oct. 12, 2005

(30) Foreign Application Priority Data
Apr. 18, 2003 (EP) 03101092.9
Sep. 26, 2003 (EP) 03103583.5

(51) Int. Cl. G06F 17/30

(52) U.S. Cl. 707/10

(57) ABSTRACT

The invention relates to cryptographic identification in a practical, low cost environment. A secret number (a kind of hidden identity) is stored in a device that, in combination with its public identity, can be used for identification by a Certifying Authority (CA) and subsequent subscription. To enable efficient renewed subscription, the CA will store a mapping of the hidden identity.

The invention relates to a method of secure device subscription, wherein a secret identifier and a public identifier are stored in a subscribing device, the subscribing device subscribes itself to a subscription authority, involving a step in which the subscribing device identifies itself with the public identifier, and a step in which the subscription authority supplies subscription information to the subscribing device.

The invention further relates to a subscription authority device, a subscribing device, a system, and a signal for secure device subscription.

In consumer applications, the production cost of a device is of utmost importance. Consequently, the ICs used in these applications preferably use standard and cheap process technology without any features like FLASH memory. A major problem then is that after a power-down of the device (such as when replacing the device's battery), any information not stored in ROM is lost. This is also true for the cryptographic information of a device. Of course dedicated cryptographic information could be stored in ROM during production but this will in general make systems less flexible. If only the device's cryptographic identity is stored in ROM, the device has no way of proving its identity after power-down as this identity is public (it is used for addressing by other devices) and can therefore be spoofed by any other device.

Well-known public key infrastructure (PKI) technology uses therefore a pair of a public key and a private key. A device identifies itself with a public key, and it can prove to others with access to the public key that it is in possession of the corresponding private key without releasing that private key. Often, the public key is also used to address that device.

In some applications the overhead in terms of processing time and code size of the algorithms implementing the PKI technology is too large. An example of such an application is low-cost devices with wireless connections (sensors, home-security, building automation, remote metering, toys, mice, key boards, etc.) Every single device has a unique identifier stored in non-volatile memory (ROM). This identifier is used by other devices, directly or indirectly, for addressing purposes within a local network. Before a new device (for example, just bought in a shop) can enter a (secured) network, it has to subscribe at a subscription authority which then acts as a Certifying Authority (CA). The CA and the device exchange subscription information in a (partially) secure environment. After this, the subscribing device can take part in the network communications. After power-down, the device looses all subscription information and the CA has no way of verifying if the received identity is indeed the identity stored in the device. The only way out is to renew subscription to the network that is, in general, a time consuming and tedious process.

It is an object of the current invention to provide a method that enables the implementation of a low-cost and efficient subscription protocol, especially the protocol to renew subscription.

This object is realized by a method according to the invention characterized in that the method has a first-time subscription protocol and a renewed subscription protocol, the subscription authority obtains a mapping of the secret identifier during the execution of the first-time subscription protocol, the subscription authority subsequently stores the mapping of the secret identifier, and the subscription authority uses the stored mapping of the secret identifier during the execution of the renewed subscription protocol.

The advantage of the invention is that devices no longer have to include non-volatile memory like FLASH or EEPROM which reduces device costs. By having the subscription authority store a mapping of the secret identifier, that has been obtained during the execution of the first-time subscription protocol, a more efficient renewed subscription protocol can be executed when a subscribing device wants to renew its subscription, for example after a power down in which it lost its subscription information. The protocols are therefore cheap and efficient to implement, and are often already available in these devices, as they often have at least some symmetric encryption algorithm implemented.

An embodiment of the method according to the invention is described in claim 2. In this embodiment of the invention both the subscription authority and the subscribing device commonly and securely obtain a value r. This value is then encrypted by the subscribing device using the secret identifier, and subsequently communicated to the subscription authority. The value r can advantageously be applied during the renewed subscription. It can also advantageously be applied for other purposes, such as to store a backup of local information at the subscription authority, such that the local information remains available during or after the absence of a subscribing device, for example because of a power down, or because the device is outside the range of the network. Another advantage of the usage of the value r is that the subscription authority doesn't learn anything about the secret identifier. When the subscribing device would subscribe to a different subscription authority in a different network, a different value r would be used and therefore the subscriptions do not conflict with each other and the subscription authorities only have information relevant to their network.

An embodiment of the method according to the invention is described in claim 3. It describes how the subscription authority and subscribing device commonly and securely obtain a value r, namely, the subscription authority generates the value r, and subsequently communicates it securely to the subscribing device.

An embodiment of the method according to the invention is described in claim 4. It describes how the subscription authority and subscribing device commonly and securely obtain a value r, namely, the subscription authority and the subscribing device together execute a protocol in order to arrive at a common secret value r.

An embodiment of the method according to the invention is described in claim 5. Both the first-time subscription protocol and the renewed subscription protocol are based on the communication from the subscription authority to the subscribing device of subscription information that is encrypted with the value r. Because this value r is only known to the subscription authority and the subscribing device, this communication does not need to be secured.

An embodiment of the method according to the invention is described in claim 6. After a power down of the subscribing device, the value r is no longer available to the subscribing device. Therefore the subscription authority communicates the value r, encrypted with the secret identifier as encryption key. This way, the subscribing device with the secret identifier can decrypt the communicated value and retrieve the value r, which it can then use further, for example to decrypt the communicated encrypted subscription information in the embodiment described in claim 5. Other devices than the subscribing device can not obtain the value of r, and the communication therefore does not need to be protected.

An embodiment of the method according to the invention is described in claim 7. The subscription authority stores the value r encrypted with the secret identifier as encryption key, which it needs during the execution of the renewed subscription protocol.

An embodiment of the method according to the invention is described in claim 8. The subscription authority not only stores the encrypted value r, but also the value r itself. This embodiment has the advantage that the subscription authority has access to the value r which it can use to encrypt and decrypt all kinds of information that is communicated to or from the subscribing device. Not only the subscription information, but any information during execution of the subscription protocol or during normal operation can be secured in this way.

An embodiment of the method according to the invention is described in claim 9. In this embodiment of the invention the subscribing device securely communicates the secret identifier to the subscription authority. The advantage of this embodiment is that it is a very simple and therefore low-cost implementation of the invention.

An embodiment of the method according to the invention is described in claim 10. The subscription information is sent from the subscription authority to the subscribing device in encrypted form with the secret identifier as the encryption key. The advantage is that the symmetric key algorithm is efficient and low-cost.

An embodiment of the method according to the invention is described in claim 11. The subscription authority stores the secret identifier locally. The secret identifier can then be used during the execution of the renewed subscription protocol.

An embodiment of the method according to the invention is described in claim 12. The subscription information is communicated securely to the subscribing device during execution of the first-time subscription protocol. The subscribing device encrypts the subscription information using the secret identifier as encryption key, and returns this information to the subscription authority. This embodiment has the advantage that the subscription authority can then use this encrypted subscription information during the execution of the renewed subscription protocol.

An embodiment of the method according to the invention is described in claim 13. The subscription authority communicates the subscription information, encrypted with the secret identifier of the subscribing device, to the subscribing device during the execution of the renewed subscription protocol.

An embodiment of the method according to the invention is described in claim 14. The subscription authority stores the subscription information, encrypted with the secret identifier of the subscribing device. This enables the subscription authority to use this information during the execution of the renewed subscription protocol.

The subscription authority device according to the invention is characterized in that the subscription authority device is arranged to implement a first-time subscription protocol, during which it receives a mapping of a secret identifier of a subscribing device, the subscription authority device is arranged to store the mapping of the secret identifier, the subscription authority device is further arranged to implement a renewed subscription protocol, during which it uses the stored mapping of the secret identifier.

The subscribing device according to the invention is characterized in that the subscribing device is arranged to contain a public identifier and a secret identifier, the subscribing device is further arranged to implement a first-time subscription protocol, during which it transmits a mapping of the secret identifier and during which it receives subscription information, the subscribing device is further arranged to implement a renewed subscription protocol, during which it receives subscription information which requires the secret identifier for decryption.

The system according to the invention is characterized in that it comprises a subscribing device as described in claim 16, and a subscription authority device as described in claim 15. The system according to the invention allows to build a secure and flexible system that allows, renewed subscription of devices, even if the devices move between different networks or are repeatedly switched off and on.

The signal according to the invention is characterized in that the signal carries a mapping of a secret identifier of a subscribing device.

An embodiment of the method according to the invention is described in claim 19. A router device that is in close connection with the subscribing device acts as the subscription authority.

An embodiment of the method according to the invention is described in claim 20. Different router devices may act as independent subscription authorities.

An embodiment of the method according to the invention is described in claim 21. A group of router devices may act as a single virtual subscription authority. The router devices are interconnected in order to exchange for example the public identifier and the mapping of the secret identifier.

An embodiment of the method according to the invention is described in claim 22. After identification the subscribing device communicates local data to the subscription authority, and the subscription authority stores the local data for later retrieval or use.

An embodiment of the method according to the invention is described in claim 23. The subscribing device may retrieve the local data from the subscription authority.

An embodiment of the method according to the invention is described in claim 24. During or after execution of the first-time subscription protocol the subscribing device encrypts local data using the secret identifier as encryption key, the subscribing device subsequently communicates the encrypted local data to the subscription authority, and the subscription authority stores the encrypted local data for later retrieval or use. If the local data is encrypted by a key unknown to the subscription authority, the data is used as a backup for the subscribing device only.

An embodiment of the method according to the invention is described in claim 25. During or after execution of the first-time subscription protocol the subscribing device encrypts local data using the secret identifier as encryption key, the subscribing device subsequently communicates the encrypted local data to the subscription authority, the subscription authority decrypts the encrypted local data and stores the local data. As the local data is encrypted by a key known to the subscription authority, the data is available for use by the subscription authority or other users.

An embodiment of the method according to the invention is described in claim 26. During or after execution of the first-time subscription protocol the subscribing device encrypts local data using the value r as encryption key, the subscribing device subsequently communicates the encrypted local data to the subscription authority, and the subscription authority stores the encrypted local data for later retrieval or use. If the local data is encrypted by a key unknown to the subscription authority, the data is used as a backup for the subscribing device only.

An embodiment of the method according to the invention is described in claim 27. During or after execution of the first-time subscription protocol the subscribing device encrypts local data using the value r as encryption key, the subscribing device subsequently communicates the encrypted local data to the subscription authority, the subscription authority decrypts the encrypted local data and stores the local data. As the local data is encrypted by a key known to the subscription authority, the data is available for use by the subscription authority or other users.

These and other aspects of the invention will be further described by way of example and with reference to the drawings, in which:

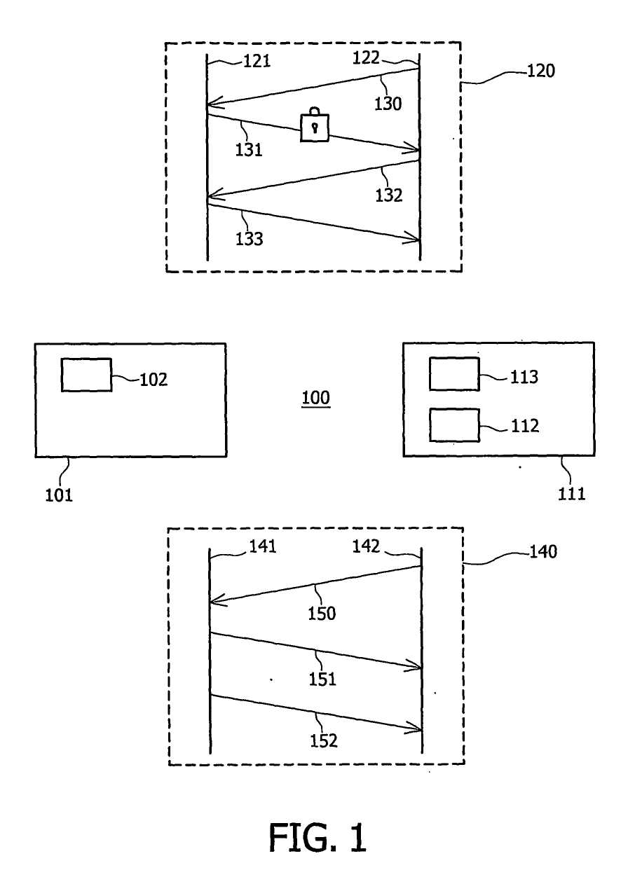

FIG. 1 illustrates a system with a first implementation of the first-time and renewed subscription protocols,

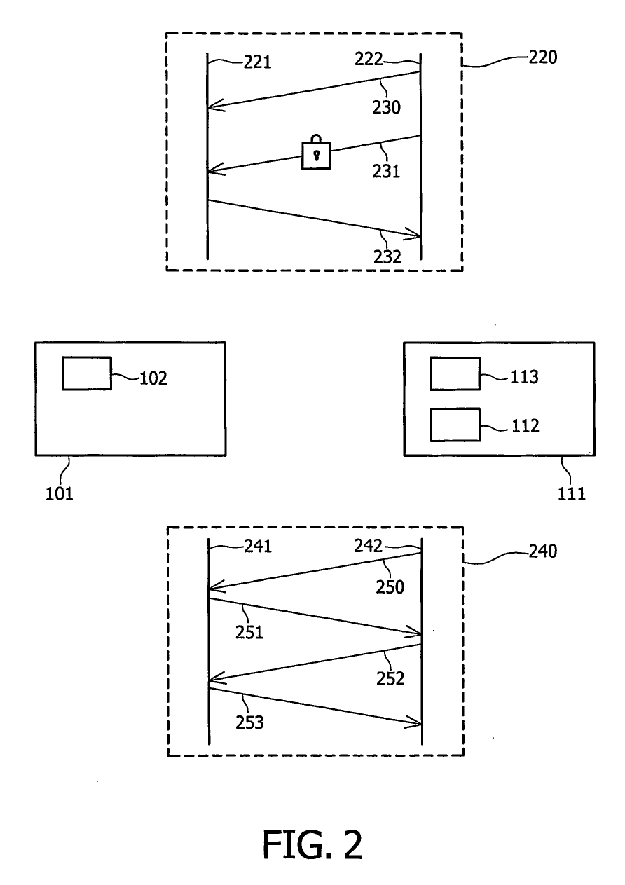

FIG. 2 illustrates a system with a second implementation of the first-time and renewed subscription protocols,

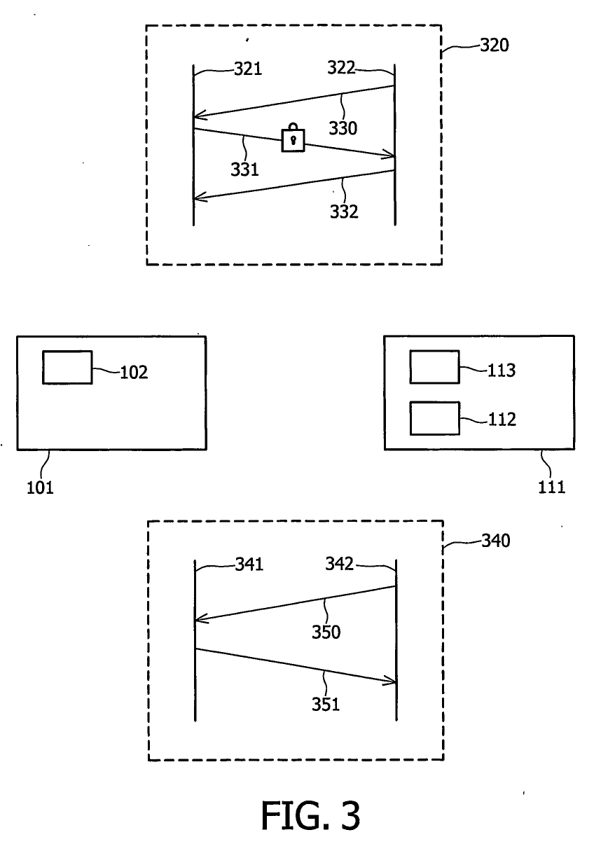

FIG. 3 illustrates a system with a third implementation of the first-time and renewed subscription protocols,

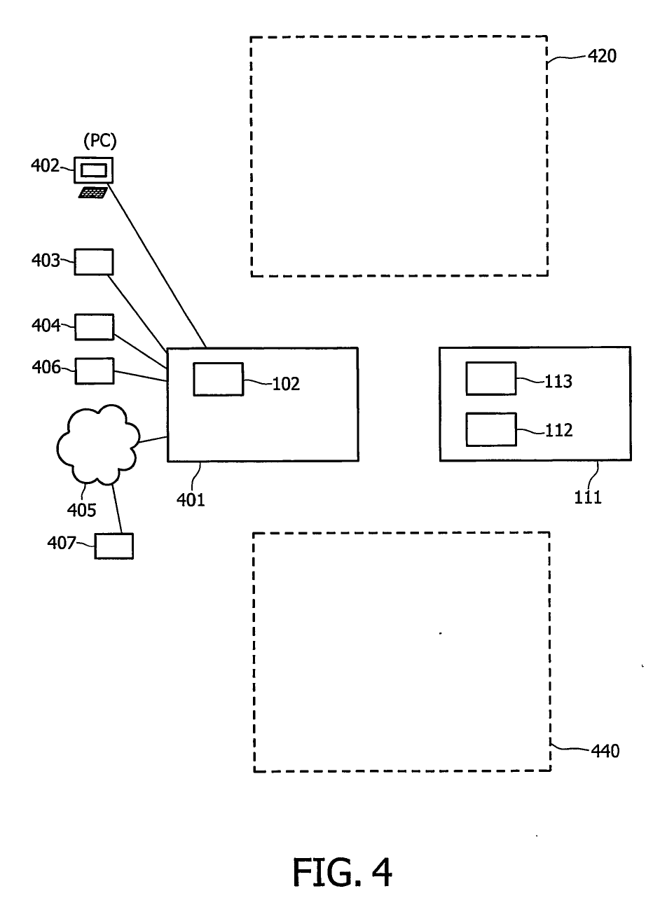

FIG. 4 illustrates a system with a router device acting as subscription authority, and

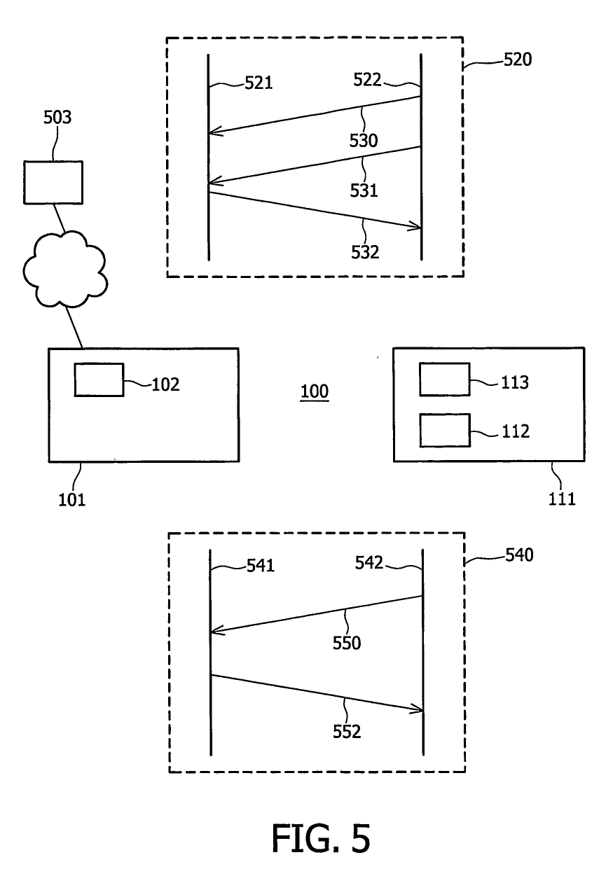

FIG. 5 illustrates a system with a subscription authority storing local data.

Throughout the figures, same reference numerals indicate similar or corresponding features. Some of the features indicated in the drawings are typically implemented in software, and as such represent software entities, such as software modules or objects.

The first three embodiments describe three different subscription protocol implementations. The fourth and following embodiments describe further variations or extensions.

A first embodiment of the invention will be illustrated by the example shown in FIG. 1. FIG. 1 shows an example of a system of (wireless) connected devices. System 100 contains a subscription authority 101 and a subscribing device 111. The subscribing device contains a public identifier 112 and a secret identifier 113. The first-time subscription protocol 120 illustrates on the hand of the communications symbolized between the subscription authority timeline 121 and the subscribing device timeline 122. During communication 130 the public identifier 112 is sent to the subscription authority in order to identify the subscribing device. Subsequently, the value r is sent to the subscribing device in secure communication 131. The value r can also be stored in memory 102 within the subscription authority device for later usage. This memory is preferably secured against tampering. A padlock in FIG. 1 symbolizes a secure connection. The connection can for example be secured by symmetric key encryption. The value r is then encrypted by the subscribing device using the secure identifier and communicated in step 132 to the subscription authority. The subscription authority 101 stores the encrypted value in its memory 102. Finally, the subscription authority encrypts the subscription information using the value r and sends this information in step 133 to the subscribing device.

A renewed subscription is more efficient than a first-time subscription. The renewed subscription 140 consists of the subscribing device identifying itself in step 150, after which the subscription authority transmits the value r, encrypted with the secret identifier, in step 151. This is a low-cost operation, as this value is already available in memory 102. Subsequently, the subscription authority transmits in step 152 the subscription information, encrypted using the value r. This information could have been stored in memory 102 or can be recomputed. The subscribing device retrieves the value r using its secret identifier, and then retrieves the subscription information.

The secure authenticated channel in step 131 can be for example a cryptographically secure channel, or a physically secure channel where no eavesdropping is possible (for a physically secured channel one could think of a Faraday room, near-field communication, or reduced power radio communication).

For the invention it is not required that the subscription authority and subscribing device share common secret information, and instead of communicating the common value r it can also be obtained for example by using algorithms like Diffie-Hellman key establishment or Shamir's no-key protocol (see Alfred J. Menezes, Paul C. van Oorschot, Scott A. Vanstone, Handbook of Applied Cryptography, p 515 and p 499, respectively) to generate a common value r.

This protocol is safe from an attack from a pseudo-subscription authority, pretending to be a subscription authority, in order to obtain information to impersonate a subscribing device or to retrieve sufficient information to successfully eavesdrop on the communication. Practically, it would be possible to remove the batteries from the subscribing device, replace the batteries and initiate a subscription protocol with a pseudo-subscription authority. But because the value r is chosen by the subscription authority, the pseudo-subscription authority does not learn sufficient information to compromise the communication between subscription authority and subscribing device.

FIG. 2 shows a second embodiment of the invention. During the execution of the first-time subscription protocol, the subscribing device reveals its public identity in step 230. In step 231 the secret identifier is communicated securely to the subscription authority as well. Subsequently, the subscription authority encrypts the subscription information using the secret identifier and communicates the encrypted subscription information to the subscribing device in step 232.

The renewed subscription is even simpler, as it consists of only two steps (step 251 and 252 optional). In step 250 the subscribing device identifies itself, and in step 253 the subscription authority communicates the encrypted subscription information to the subscribing device. The encrypted subscription information can be obtained from storage 102 (if it does not change) or it can be recomputed (if the subscription information has changed) by encrypting it using the secret identifier. The subscribing device can decrypt this information using its secret identifier. The authorization is implicit: only the subscribing device with access to the secret identifier can obtain the subscription information.

It can also do explicit authentication by starting a challenge response-protocol of which a simple version is described here but any symmetric key based challenge-response will do. In this simple version, step 251 may communicate the value r encrypted using the secret identifier to the device as a challenge, and the subscribing device should return the value r to the subscription authority in step 252. Failing that, the subscription authority will refuse the subscribing device.

FIG. 3 shows a third embodiment of the invention. During the execution of the first-time subscription protocol, the subscribing device reveals its public identity in step 330. In step 331 the subscription information is communicated securely from the subscription authority to the subscribing device. Subsequently, the subscribing device encrypts the subscription information using the secret identifier and communicates the encrypted subscription information to the subscription authority in step 332.

This embodiment has the advantage that the secret identifier does not leave the subscribing device.

The renewed subscription is as simple as in the previous embodiment. In step 350 the subscribing device identifies itself, and in step 351 the subscription authority communicates the stored encrypted subscription information to the subscribing device. The subscribing device can decrypt this information using its secret identifier. The authorization is implicit: only the subscribing device with access to the secret identifier can obtain the subscription information.

FIG. 4 shows a fourth embodiment. In this embodiment a router device 401 that is used to connect the subscribing device to a network may implement the subscription authority functionality, in addition to the router device normally operating as a router between the subscribing device 111 and other devices such as a PC 402, peripheral devices 403-404, and the Internet 405.

The subscribing device can be connected to the router device for example by establishing a wireless connection, by using a wired cable, or by using infrared communication. The router device is therefore the device “closest” to the subscribing device and can advantageously operate as a subscription authority, using any of the subscription protocols described in the first three embodiments. A first-time subscription protocol 420 and renewed subscription protocol 440 can refer to either protocols 120 and 140, 220 and 240, or 320 and 340 respectively as shown in FIG. 1-3. The short line of communication is advantageous because it reduces the security risks, communication length, and communication latency. In a practical environment, different router devices may be used that allow connections from the subscribing device. These router devices may be connected directly or indirectly to other similar router devices with subscription authority functionality 406-407.

In a first variation of this embodiment, these router devices may operate as independent subscription authorities. This may happen for example if these router devices with subscription authority functionality belong to different networks or different users. When the subscribing device is switched to a different router device, a simple renewed subscription protocol with the different router device is sufficient provided that a first-time subscription protocol has been executed with that different router device.

In a second variation of this embodiment, a router device may be part of a group of router devices that interoperate in order to act as the same virtual subscription authority. This approach may be used to increase the number of locations or to enlarge the region in which the subscribing device can be used. For example, in wireless applications multiple base stations may be required to increase the area covered or to distribute the bandwidth load over multiple base stations. The subscribing device can be moved either logically or physically between these different router devices. The router device to which the subscribing device is connecting, retrieves the secret information from one of the previously active router devices in the same group. Alternatively, any router device of the group of router devices or a different device stores the secret information centrally. The group of router devices co-operating as virtual subscription authority may be different for different subscribing devices.

FIG. 5 shows a fifth embodiment. In this embodiment the subscription authority provides remote storage functionality for the subscribing device. Together with the mapping of the secret identifier, additional local data is stored by the subscription authority. This local data can be used by the subscribing device. Depending on the application, different advantages are achieved. A first potential advantage is that the local data survives a power down of the subscribing device. A second potential advantage is that the subscribing device can store more data than fits in the device itself. A third potential advantage is that the subscribing device can store different versions of local data, for example configuration data, at different subscription authorities that it may (re)connect to. Instead of storing the local data at the subscription authority storage itself, for example also in the storage area 102, the subscription authority may use a different local data storage device 503 to store the local data. Different subscription authorities, either functioning independently or together, may use the same or different local data storage devices.

The protocol 520 starts with the subscribing device identifying itself through the communication 530 of its public identifier. This may be the first step of the first-time or renewed subscription protocol, but may also be a separate communication of the public identifier, only meant to access the local data at the subscription authority. Subsequently, the local data can be sent to or received from the subscription authority 101 as visualized by communication 531 and 532. After disconnecting and reconnecting the subscribing device, the subscribing device can identify itself again in step 550 and access the local data again, for example by reading it as in communication 552.

In this embodiment the subscription authority can either be the router from embodiment 4 operating as subscription authority or a separate subscription authority as described in embodiments 1-3. If multiple router devices operate as virtual subscription authority they will need to use the same common storage device or interchange the local data storage.

In a first variation of this embodiment the subscribing device uses the secret identifier to encrypt the local data. This variation can be used with any of the first three subscription protocols of the first three embodiments. If this first variation is used with the subscription protocol from the first or third embodiment, the subscription authority stores the local data encrypted with the secret identifier, but as the subscription authority does not have the secret identifier, it cannot access the data. The data is used only for later retrieval by the subscribing device itself. If this first variation is used with the subscription protocol from the second embodiment, the subscription authority has access to the secret identifier after the first-time subscription, and can therefore decrypt the encrypted local data. The subscription authority can therefore use or further communicate the local data.

In a second variation of this embodiment the subscription protocol of the first embodiment is used. In this variation, the subscribing device uses the value r to encrypt the local data before communication 530 occurs.

The mere fact that certain measures are recited in mutually different dependent claims does not indicate that a combination of these measures cannot be used to advantage.

Alternatives are possible. In the description above, “comprising” does not exclude other elements or steps, “a” or “an” does not exclude a plurality, and a single processor or other unit may also fulfill the functions of several means recited in the claims. Actual communication includes the actual communication between different devices or parts of a device, by means of optical, electronic, wireless, microwave, or any other suitable technology, or even communication between software components within a processing system or between processing systems.

1. A method of secure device subscription, wherein
a secret identifier and a public identifier are stored in a subscribing device,
the subscribing device subscribes itself to a subscription authority, involving
a step in which the subscribing device identifies itself with the public identifier, and
a step in which the subscription authority supplies subscription information to the subscribing device,
characterized in that
the method has a first-time subscription protocol and a renewed subscription protocol,
the subscription authority obtains a mapping of the secret identifier during execution of the first-time subscription protocol,
the subscription authority subsequently stores the mapping of the secret identifier, and
the subscription authority uses the stored mapping of the secret identifier during execution of the renewed subscription protocol.

2. The method according to claim 1, wherein during execution of the first-time subscription protocol
the subscription authority and subscribing device commonly and securely obtain a value r,
the subscribing device subsequently encrypts the value r using the secret identifier as encryption key, and
the subscribing device subsequently communicates the encrypted value to the subscription authority.

3. The method according to claim 2, wherein during execution of the first-time subscription protocol
the subscription authority generates the value r, and
the subscription authority communicates the value r securely to the subscribing device.

4. The method according to claim 2, wherein during execution of the first-time subscription protocol the subscription authority and subscribing device commonly generate a value r using a secure common key generation protocol.

5. The method according to claim 2, wherein during execution of any of the subscription protocols
the subscription authority encrypts the subscription information using the value r as encryption key, and
the subscription authority subsequently communicates the encrypted subscription information to the subscribing device.

6. The method according to claim 2, wherein during execution of the renewed subscription protocol the subscription authority communicates the value r encrypted with the secret identifier as encryption key to the subscribing device.

7. The method according to claim 2, wherein the stored mapping of the secret identifier is the value r, encrypted with the secret identifier as encryption key.

8. The method according to claim 7, wherein the value r is also stored by the subscription authority.

9. The method according to claim 1, wherein during execution of the first-time subscription protocol the subscribing device communicates the secret identifier to the subscription authority.

10. The method according to claim 1, wherein during execution of any of the subscription protocols
the subscription authority encrypts the subscription information using the secret identifier, and
the subscription authority subsequently communicates the encrypted subscription information to the subscribing device.

11. The method according to claim 1, wherein the stored mapping of the secret identifier is the secret identifier itself.

12. The method according to claim 1, wherein during execution of the first-time subscription protocol
the subscription authority communicates the subscription information securely to the subscribing device,
the subscribing device subsequently encrypts the subscription information using the secret identifier as encryption key, and
the subscribing device subsequently communicates the encrypted subscription information to the subscription authority.

13. The method according to claim 1, wherein during execution of the renewed subscription protocol the subscription authority communicates the encrypted subscription information to the subscribing device.

14. The method according to claim 1, wherein the stored mapping of the secret identifier is the subscription information encrypted with the secret identifier as encryption key.

15. A subscription authority device for secure device subscription, characterized in that
the subscription authority device is arranged to implement a first-time subscription protocol, during which it receives a mapping of a secret identifier of a subscribing device,
the subscription authority device is arranged to store the mapping of the secret identifier,
the subscription authority device is further arranged to implement a renewed subscription protocol, during which it uses the stored mapping of the secret identifier.

16. A subscribing device to participate in a network requiring subscription, characterized in that
the subscribing device is arranged to contain a public identifier and a secret identifier,
the subscribing device is further arranged to implement a first-time subscription protocol,
during which it transmits a mapping of the secret identifier and during which it receives subscription information,
the subscribing device is further arranged to implement a renewed subscription protocol,
during which it receives subscription information which requires the secret identifier for decryption.

17. A system for secure device subscription, the system comprising
a subscribing device is described in claim 16, and
a subscription authority device is described in claim 15.

18. A signal for secure device subscription, characterized in that the signal carries a mapping of a secret identifier of a subscribing device.

19. The method according to claim 1, wherein a router device that is in connection with the subscribing device acts as the subscription authority.

20. The method according to claim 19, wherein the router device acts as an independent subscription authority.

21. The method according to claim 19, wherein a router device from a group of router devices may act as a virtual single subscription authority.

22. The method according to claim 1, wherein
the subscribing device communicates local data to the subscription authority, and
the subscription authority stores the local data.

23. The method according to claim 22, wherein the subscribing device retrieves at least part of the stored local data from the subscription authority.

24. The method according to claim 1, wherein
the subscribing device encrypts local data using the secret identifier as encryption key,
the subscribing device subsequently communicates the encrypted local data to the subscription authority, and
the subscription authority stores the encrypted local data.

25. The method according to claim 1, wherein
the subscribing device encrypts local data using the secret identifier as encryption key,
the subscribing device subsequently communicates the encrypted local data to the subscription authority, and
the subscription authority decrypts the encrypted local data and stores the decrypted local data.

26. The method according to claim 2, wherein
the subscribing device encrypts local data using the value r as encryption key,
the subscribing device subsequently communicates the encrypted local data to the subscription authority, and
the subscription authority stores the encrypted local data.

27. The method according to claim 2, wherein
the subscribing device encrypts local data using the value r as encryption key,
the subscribing device subsequently communicates the encrypted local data to the subscription authority, and
the subscription authority decrypts the encrypted local data and stores the decrypted local data.
